(19) United States
(12) Patent Application Publication
(10) Pub. No.: US 2026/0358787 A1
(43) Pub. Date: Nov. 12, 2026

(54) METHOD, DEVICE AND PROGRAM FOR PROVIDING HEATING PROFILE

(71) Applicant: Japan Tobacco Inc., Tokyo (JP)

(72) Inventors: Ken OSAWA, Tokyo (JP); Masato KATO, Tokyo (JP)

(73) Assignee: Japan Tobacco Inc., Tokyo (JP)

(21) Appl. No.: 19/134,767

(22) PCT Filed: Dec. 9, 2022
(86) PCT No.: PCT/JP2022/045397

§ 371 Date: Jun. 2, 2025

(51) Int. Cl. G05B 19/4155

(52) U.S. Cl. CPC G05B 19/4155; G05B 2219/50333

(57) ABSTRACT

A method executed by a computer device that has profile storage to a plurality of heating process control profiles for an aerosol generator in association with brand information, the brand information including an aerosol source brand and information indicating the flavor of the brand; and an extraction condition information storage that stores extraction condition information that depends on the user of the aerosol generator and for extracting at least one profile from the plurality of heating process control profiles. The profile storage further stores the plurality of heating process control profiles in association with the extraction condition information. The method includes extracting at least one profile applicable to the aerosol generator from the plurality of heating process control profiles based on the brand information and the extraction condition information stored by the extraction condition information storage.

### TECHNICAL FIELD

The present invention relates to a method, a device and a program for providing a heating profile, the method, device and program being intended for providing a heating profile which is used in an aerosol-generating device.

### BACKGROUND ART

There are known heat-not-burn aerosol-generating devices, such as electronic cigarettes and heated tobacco, which deliver an aerosol generated by atomizing an aerosol source with a heater to a user. The heater is heated by means of power stored in a battery, so a heating profile and battery power consumption need to be suitably controlled.

A heating profile in which a maximum temperature is first of all reached after heating starts, then there is a gradual reduction in temperature, is known as an example of the heating profile. Furthermore, there is a method of adopting a heating profile in which a temperature is maintained for a predetermined time after a fall in temperature, but the temperature is increased again after the temperature has been maintained for the predetermined time, in order to increase the quality of aerosol provision, because the amount of aerosol provided to the user decreases as the amount of aerosol remaining in the aerosol source decreases.

Furthermore, PTL 1 indicates, for example, that a suitable heating profile is selected according to the type of cigarette.

### CITATION LIST

### Patent Literature

PTL 1: JP 2020-526208 A

### SUMMARY OF INVENTION

### Technical Problem

However, PTL 1 relates only to selecting a suitable heating profile according to the type of cigarette. Furthermore, the specific nature of the information constituting the type of cigarette is unclear in PTL 1, and even for cigarettes with the same product name, for example, the feeling from inhalation also differs according to the taste, such as menthol or flavored. Furthermore, the user may seek a different feeling from inhalation depending on their preference and their situation at different times. Thus, the quality of the aerosol to be inhaled can be varied and the user can have a higher quality experience if the heating profile can be changed to vary the feeling from inhalation according to the user's preferences or the user's situation. However, PTL 1 makes no mention of such a concept.

The present invention takes account of the problem above, and the objective of the present invention lies in providing a method for providing a suitable heating profile according to the flavor of an aerosol source, a user's preference, or a user's situation.

### Solution to Problem

In order to solve the problem above, one aspect of the present invention provides a method executed by means of a computer device, wherein the computer device comprises: a profile storage unit for storing a plurality of profiles for controlling a heating process in an aerosol-generating device for generating an aerosol, the profiles being stored in association with brand information including a brand of an aerosol source undergoing the heating process in the aerosol-generating device and information indicating a flavor of the brand; and an extraction condition information storage unit for storing extraction condition information which is information dependent on a user of the aerosol-generating device and is information for extracting at least one profile from among the plurality of profiles, and wherein the profile storage unit further stores the plurality of profiles and the extraction condition information in association with each other, and the method comprises: a step of extracting at least one profile applicable to the aerosol-generating device from among the plurality of profiles, based on the brand information and the extraction condition information stored in the extraction condition storage unit.

The extraction condition information may be information relating to a time at which the user uses the aerosol-generating device.

The extraction condition information may be inhalation tendency information relating to an inhalation tendency of the user of the aerosol-generating device.

The extraction condition information may be attribute information relating to personal data of the user.

The extraction condition information may be information relating to a location where the user uses the aerosol-generating device.

The extraction condition information may be preference information relating to a preference of the user.

The extraction condition information may be information dependent on the user at a time when the user uses the aerosol-generating device.

The method may further comprise a step of receiving the extraction condition information from externally to the computer device.

The method may further comprise a step of outputting a list of said at least one profile extracted in the step of extracting said at least one profile.

Furthermore, in order to solve the problem above, a different aspect of the present invention provides a computer device for providing a profile for controlling a heating process in an aerosol-generating device for generating an aerosol, the computer device comprising: a profile storage unit for storing a plurality of said profiles in association with brand information including a brand of an aerosol source undergoing the heating process in the aerosol-generating device and information indicating a flavor of the brand; and an extraction condition information storage unit for storing extraction condition information which is information dependent on a user of the aerosol-generating device and is information for extracting at least one profile from among the plurality of profiles, wherein the profile storage unit further stores the plurality of profiles and the extraction condition information in association with each other, and the computer device further comprises a profile extraction unit for extracting at least one profile applicable to the aerosol-generating device from among the plurality of profiles, based on the brand information and the extraction condition information stored in the extraction condition storage unit.

Furthermore, in order to solve the problem above, another aspect of the present invention provides a program for causing a computer device to execute the method above.

### Advantageous Effects of Invention

The present invention as described above provides a system enabling an even better quality of user experience with an aerosol-generating device by recommending a suitable heating profile according to the flavor of an aerosol source, user preference, or user situation.

### BRIEF DESCRIPTION OF DRAWINGS

FIG. 1 shows a configuration example of a heating profile provision system according to an embodiment of the present invention.

FIG. 2A schematically shows a first configuration example of an aerosol-generating device according to an embodiment of the present invention.

FIG. 2B schematically shows a second configuration example of an aerosol-generating device according to an embodiment of the present invention.

FIG. 3 shows an example of a functional block diagram of the server device according to an embodiment of the present invention.

FIG. 4 shows an example of inhalation tendency information.

FIG. 5 shows an example of attribute information.

FIG. 6 shows an example of preference information.

FIG. 7 shows an example of information stored in a profile storage unit of the server device according to an embodiment of the present invention.

FIG. 8 shows a different example of information stored in the profile storage unit of the server device according to an embodiment of the present invention.

FIG. 9 shows a different example of information stored in the profile storage unit of the server device according to an embodiment of the present invention.

FIG. 10 shows a hardware configuration example of the server device according to an embodiment of the present invention.

FIG. 11 shows an example of a processing flow in a heating profile provision system according to an embodiment of the present invention.

FIG. 12 shows an example of a detailed processing flow in step S2.

### DESCRIPTION OF EMBODIMENTS

Embodiments of the present invention will be described in detail below with reference to the drawings.

### Configuration of Heating Profile Provision System

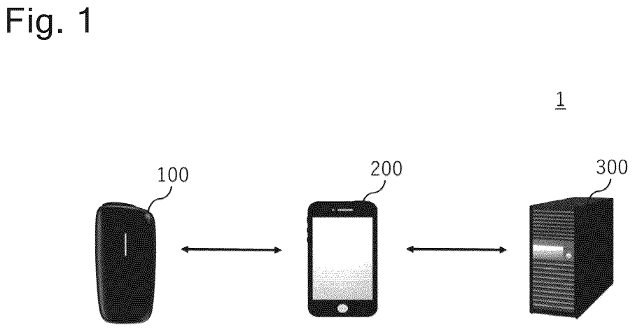

FIG. 1 shows a configuration example of a heating profile provision system according to this embodiment. A heating profile provision system 1 according to this embodiment may comprise: an aerosol-generating device 100, an external device 200, and a server device 300. The aerosol-generating device 100 is a device for inhalation of a generated aerosol, and is an electronic cigarette or heated tobacco, etc., for example. Furthermore, the aerosol-generating device 100 may be what is known as a reduced-risk product (RRP).

The external device 200 is a user device predominantly expected to be used by a user of the aerosol-generating device 100. The external device 200 may be configured as a typical computer device, but is more preferably a portable computer device such as a smartphone, a feature phone, a personal digital assistant (PDA), a notebook computer, or a tablet computer. However, this is not limiting. The external device 200 may be a stationary computer device such as a desktop computer, for example. The aerosol-generating device 100 and the external device 200 may send/receive data to/from each other by means of wired or wireless communication technology. Furthermore, the server device 300 is a computer device capable of communication with the external device 200 by means of wired or wireless communication technology. Furthermore, the server device 300 sends/receives data relating to the aerosol-generating device 100 to/from the external device 200.

### Configuration of Aerosol-Generating Device

A configuration example of the aerosol-generating device 100 according to this embodiment will be described below.

### First Configuration Example

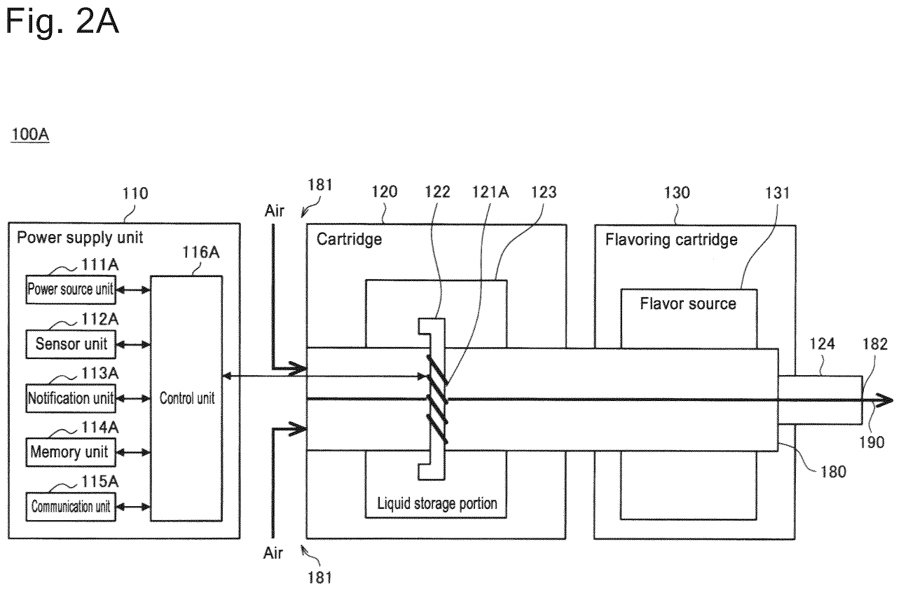

FIG. 2A schematically shows a first configuration example of the aerosol-generating device. As shown in FIG. 2A, an aerosol-generating device 100A according to this configuration example comprises a power supply unit 110, a cartridge 120, and a flavoring cartridge 130. The power supply unit 110 comprises a power source unit 111A, a sensor unit 112A, a notification unit 113A, a memory unit 114A, a communication unit 115A, and a control unit 116A. The cartridge 120 includes a heating unit 121A, a liquid guiding portion 122, and a liquid storage portion 123. The flavoring cartridge 130 includes a flavor source 131 and a mouthpiece 124. An air flow path 180 is formed in the cartridge 120 and the flavoring cartridge 130.

It should be noted that the cartridge 120 and the flavoring cartridge 130 are also referred to as “refills”. In this embodiment, a two-dimensional code such as a QR code (registered trademark), which indicates brand information including the brand of the refill and the flavor of that brand, is attached to one of the refills 120 and 130 (however, a two-dimensional code is merely an example and is not limiting, and the brand information of the refills may be represented by text, graphics or colors, etc.).

The power source unit 111A stores electrical power. The power source unit 111 then supplies the electrical power to each component of the aerosol-generating device 100 in accordance with control performed by the control unit 116A. The power source unit 111A may be configured, for example, by a rechargeable battery such as a lithium ion secondary battery.

The sensor unit 112A acquires various types of information relating to the aerosol-generating device 100A. In this embodiment, the sensor unit 112A comprises a reading sensor for reading the two-dimensional code attached to the refills 120, 130 which are fitted to the aerosol-generating device 100A. When the refills 120, 130 are fitted to the aerosol-generating device 100A, the two-dimensional code is read by means of the sensor unit 112A and the brand information of the refills 120, 130 is detected. The sensor unit 112A may further comprise a pressure sensor such as a microphone capacitor, a flow rate sensor or a temperature sensor, etc., and may be capable of acquiring values associated with inhalation by a user. Furthermore, the sensor unit 112A may comprise an input device, such as a button or a switch, for accepting input of information from the user.

The notification unit 113A notifies the user of the information. The notification unit 113A may comprise, for example, a light-emitting device for emitting light, a display device for displaying images, a sound output device for outputting sound, or a vibration device which vibrates, etc.

The memory unit 114A stores various types of information for operation of the aerosol-generating device, etc. 100A. The memory unit 114A may be configured by a non-volatile storage medium such as a flash memory, for example. The memory unit 114A may comprise a volatile memory providing a working area for control afforded by the control unit 116A. The memory unit 114A in this embodiment may store one or more heating profiles constituting a control sequence including control of a target temperature which is a target value of the temperature of the heating unit 121A (e.g., information defining a time-series transition of the target temperature of the heating unit 121A).

The communication unit 115A comprises the communication interface (including a communication module) conforming to a Bluetooth (registered trademark) or predetermined LPWA (low-power wide area) wireless communication standard, or a wireless communication standard having similar restrictions. Sigfox and LoRA-WAN, etc. may be adopted as this communication standard. The communication unit 115A may also be a communication interface capable of performing communication in accordance with any wired or wireless communication standard. For example, Wi-Fi (registered trademark), etc. may be adopted as this communication standard.

The control unit 116A functions as an arithmetic processing device and a control device, controlling all operations within the aerosol-generating device 100A in accordance with various programs. The control unit 116A is realized by a central processing unit (CPU) or an electronic circuit such as a microprocessor, for example.

The liquid storage portion 123 stores an aerosol source. The aerosol source is atomized so as to generate an aerosol. The aerosol source is a polyhydric alcohol such as glycerol or propylene glycol, or a liquid such as water, for example. In this embodiment, the aerosol source is assumed to comprise a tobacco-derived flavor component, but it is equally feasible for the aerosol source to comprise a non-tobacco-derived flavor component.

The liquid guiding portion 122 guides the aerosol source, which is the liquid stored in the liquid storage portion 123, from the liquid storage portion 123, and holds the aerosol source. The liquid guiding portion 122 is, for example, a wick formed by twisting a fibrous material such as glass fibers or a porous material such as a porous ceramic. In such case, the aerosol source stored in the liquid store portion 123 is guided by the capillary effect of the wick.

The heating unit 121A heats the aerosol source to atomize the aerosol source, thereby generating the aerosol. In the example shown in FIG. 2A, the heating unit 121A is configured as a coil and wrapped around the liquid guiding portion 122. When the heating unit 121A generates heat, the aerosol source held in the liquid guiding portion 122 is then heated and atomized, generating the aerosol. The heating unit 121A generates heat when supplied with electricity from the power source unit 111A. In this embodiment, the heating unit 121A is controlled in accordance with a heating profile. Furthermore, by way of example, electricity may be supplied to the heating unit 121A when the sensor unit 112A detects that the user has started inhaling and/or that predetermined information has been input. The supply of electricity to the heating unit 121A may then be stopped when the sensor unit 112A detects that the user has finished inhaling and/or that predetermined information has been input.

The flavor source 131 is a component for imparting a flavor component to the aerosol. In this embodiment, the flavor source 131 of this embodiment is assumed to comprise a tobacco-derived flavor component, but it is equally feasible for the for the flavor source 131 to comprise a non-tobacco-derived flavor component.

The air flow path 180 is a flow path for air to be inhaled by the user. The air flow path 180 has a tubular structure with an air inflow hole 181, which is an inlet for air into the air flow path 180, and an air outflow hole 182, which is an outlet for air from the air flow path 180. Midway through the air flow path 180, the liquid guiding portion 122 is disposed upstream (closer to the air inflow hole 181), and the flavor source 131 is disposed downstream (closer to the air outflow hole 182). Air flowing in through the air inflow hole 181 upon inhalation by the user is mixed with the aerosol generated by the heating unit 121A and transported through the flavor source 131 to the air outlet hole 182, as shown by the arrow 190. When the mixed fluid of aerosol and air passes through the flavor source 131, the flavor component contained in the flavor source 131 is applied to the aerosol.

The mouthpiece 124 is a member which is held in the user's mouth during inhalation. The air outlet hole 182 is disposed in the mouthpiece 124. The user holds the mouthpiece 124 in their mouth to make it possible to draw the mixed fluid of aerosol and air into the oral cavity.

A configuration example of the aerosol-generating device 100A was described above. The aerosol-generating device 100A is of course not limited to the configuration described above and it may have various configurations which are illustrated below.

As an example, the aerosol-generating device 100A need not include the flavoring cartridge 130. In such case, the cartridge 120 is provided with the mouthpiece 124.

Furthermore, the means for atomizing the aerosol source is not limited to heating provided by the heating unit 121A. For example, the means for atomizing the aerosol source may be induction heating.

### Second Configuration Example

FIG. 2B schematically shows a second configuration example of the aerosol-generating device. As shown in FIG. 2B, an aerosol-generating device, etc. 100B according to this configuration example comprises: a power source unit 111B, a sensor unit 112B, a notification unit 113B, a memory unit 114B, a communication unit 115B, a control unit 116B, a heating unit 121B, a holding portion 140, and a heat insulating portion 144.

The power source unit 111B, sensor unit 112B, notification unit 113B, memory unit 114B, communication unit 115B, and control unit 116B are each substantially identical to the corresponding component included in the aerosol-generating device 100A according to the first configuration example.

The holding portion 140 bas an internal space 141, and holds a stick-type substrate 150 while accommodating a portion of the stick-type substrate 150 in the internal space 141. Moreover, the stick-type substrate 150 is also an example of a “refill”. The holding portion 140 has an opening 142 allowing the internal space 141 to communicate with the outside, and holds the stick-type substrate 150 which has been inserted into the internal space 141 from the opening 142. For example, the holding portion 140 is a cylindrical body comprising the opening 142 and a bottom portion 143 serving as a bottom surface, and defines a columnar internal space 141. The holding portion 140 also has a function for defining a flow path for air supplied to the stick-type substrate 150. An air inflow hole which is an inlet for air to the flow path is disposed in the bottom portion 143, for example. Meanwhile, the opening 142 forms an air outflow hole, which is an outlet for air from the flow path.

The stick-type substrate 150 comprises a substrate portion 151 and a mouthpiece portion 152. The substrate portion 151 contains an aerosol source. It should be noted that the aerosol source may be a solid or may be a liquid in this configuration example. In a state in which the stick-type substrate 150 is being held in the holding portion 140, at least a portion of the substrate portion 151 is accommodated in the internal space 141, and at least a portion of the mouthpiece portion 152 protrudes from the opening 142. Then, when the user holds the mouthpiece portion 152 protruding from the opening 142 in their mouth and inhales, air flows into the internal space 141 via inflow hole, which is not illustrated in the drawings, and reaches the inside of the user's mouth together with the aerosol generated from the substrate portion 151. Furthermore, a two-dimensional code such as a QR code representing brand information of the stick-type substrate 150 is attached to the stick-type substrate 150 in this embodiment. When the stick-type substrate 150 is inserted into the aerosol-generating device 100B, the two-dimensional code is read by means of the sensor unit 112B and the brand information of the stick-type substrate 150 is detected. (However, a two-dimensional code is merely an example and is not limiting, and the brand information of the stick-type substrate 150 may be represented by text, graphics or colors, etc.)

The heating unit 121B has the same configuration as the heating unit 121A according to the first configuration example. However, in the example illustrated in FIG. 2B, the heating unit 121B is configured in a film shape and is disposed so as to cover the outer circumference of the holding portion 140. Then, when the heating unit 121B generates heat, the substrate portion 151 of the stick-type substrate 150 is heated from the outer circumference, generating the aerosol. Furthermore, in this embodiment, the heating unit 121B is controlled in accordance with one or more heating profiles which may be stored in the memory unit 114B.

The heat insulating portion 144 prevents heat transfer from the heating units 121B to other components. For example, the heat insulating portion 144 is configured from a vacuum heat insulating material or an aerogel heat insulating material, or the like.

A configuration example of the aerosol-generating device 100B was described above. The aerosol-generating device 100B is of course not limited to the configuration described above and it may have various configurations which are illustrated below.

As one example, the heating unit 121B may have a blade-like form and may be arranged so as to protrude into the internal space 141 from the bottom portion 143 of the holding portion 140. In that case, the blade-like heating unit 121B is inserted into the substrate portion 151 of the stick-type substrate 150 and heats the substrate portion 151 of the stick-type substrate 150 from the inside. As another example, the heating unit 121B may be arranged so as to cover the bottom portion 143 of the holding portion 140. Furthermore, the heating unit 121B may be configured by a combination of two or more from among a first heating unit covering the outer circumference of the holding portion 140, a blade-like second heating unit, and a third heating unit covering the bottom portion 143 of the holding portion 140.

As another example, the holding portion 140 may comprise an opening/closing mechanism such as a hinge for opening/closing part of a casing that forms the internal space 141. By opening/closing the casing, the holding portion 140 may then grip the stick-type substrate 150 which has been inserted into the internal space 141. In this case, the heating unit 121B may be provided on the gripping part of the holding portion 140, and may heat the stick-type substrate 150 while pressing same.

Furthermore, the means for atomizing the aerosol source is not limited to heating provided by the heating unit 121B. For example, the means for atomizing the aerosol source may be induction heating.

### Functional Block of Server

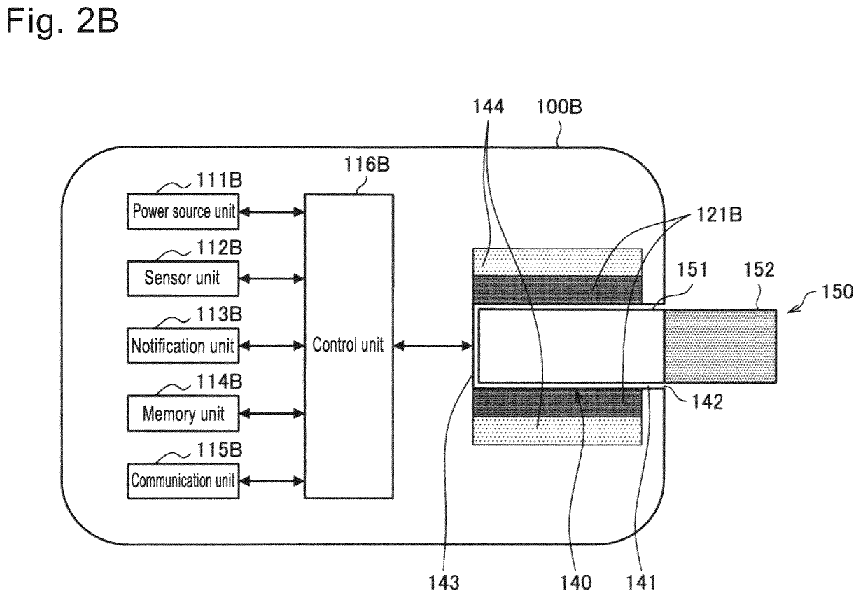

FIG. 3 shows an example of a functional block diagram of the server device 300 according to this embodiment. The server device 300 of this example may comprise: a data receiver 302, an extraction condition information storage unit 304, a log information collecting unit 306, a profile storage unit 308, a recommendation program storage unit 310, a profile extraction unit 312, and a data transmitter 314. The heating profile is information for controlling a heating process performed by the heating unit 121 in the aerosol-generating device 100. It should be noted that the “heating profile” will be referred to simply as a “profile” in the following description.

The data receiver 302 receives various types of data from the external device 200 by means of wired or wireless communication. In this embodiment, the data receiver 302 receives, via the external device 200, brand information, which is information indicating a brand of the refills 120 and 130 or the stick-type substrate 150 (these will be referred to below as the “aerosol source 120, etc.”) undergoing a heating process by means of the heating unit 121 of the aerosol-generating device 100, and also indicating a flavor of the brand. More specifically, a product name, or similar, of the aerosol source 120, etc. corresponds to the “brand”. Furthermore, the “flavor of the brand” represents categories such as taste, flavor and savor, and may correspond to categories of each brand such as “regular”, “menthol”, “flavored”, “fruity”, “sweet”, and flavors (tastes) of various foods and beverages (in the description of this embodiment, it will be assumed that there are three types of flavors, namely “regular”, “menthol” and “flavored”, in order to simplify the description). The sensor unit 112 may read the brand information from the two-dimensional code such as a QR code which is attached to the aerosol source 120, etc., when the aerosol source 120, etc. is fitted or inserted into the aerosol-generating device 100. The brand information which has been read is then output from the communication unit 115 to the external device 200. The external device 200 sends the received brand information to the server device 300. However, when the aerosol-generating device 100 and the server device 300 are capable of direct communication, the brand information may be sent directly to the server device 300 without passing via the external device 200.

Furthermore, the data receiver 302 may receive other information from the external device 200. The data receiver 302 of this embodiment receives, via the external device 200, user log information from the aerosol-generating device 100, which includes: number of times of inhalation (per single use of the aerosol-generating device 100), duration of inhalation (per single inhalation), inhalation intervals, brand information of the aerosol source being inhaled, and the profile used, etc. It should be noted that these items of information may be received directly from the aerosol-generating device 100 without passing via the external device 200. Furthermore, these items of information may be sent from the aerosol-generating device 100 to the external device 200 each time the aerosol-generating device 100 and the external device 200 are connected by means of Bluetooth communication. The external device 200 may then send the log information to the server device 300 each time this log information is received from the aerosol-generating device 100, or else at a predetermined timing. The received log information is collected by the log information collecting unit 306 which will be described later.

Furthermore, the data receiver 302 of this embodiment may receive, from the external device 200, time slot information representing the time slot at the current time of the external device 200 (at the time of inhalation), or a situation (the circumstances) at the time of inhalation, such as working hours, a rest period, a mealtime (breakfast, lunch, dinner, drinking party), etc., or else location information such as GPS (global positioning system) information. Furthermore, the external device 200 of this embodiment may provide the user of the aerosol-generating device 100 with a questionnaire in regard to the user's physical condition at the time of inhalation and desired feeling from inhalation, etc., by using a dedicated application or website, etc. running on the external device 200. The user's responses to the questionnaire are sent from the external device 200 to the server device 300.

Furthermore, the external device 200 of this embodiment may be configured beforehand to cause the user to perform an input operation in regard to personal data (attribute information), using the dedicated application or website, etc., the personal data including the user's sex, age, place of residence (or possibly the main place of use of the aerosol-generating device 100, or a region, or the name of a place, etc.), and preferred brands and flavors. The external device 200 sends the input personal data to the server device 300.

The extraction condition information storage unit 304 stores extraction condition information which is information dependent on the user of the aerosol-generating device 100 and is information for extracting at least one profile. The extraction condition information is information which may serve as an extraction condition when the profile extraction unit 312 of the server device 300 extracts a recommended profile for the aerosol-generating device 100, as will be described later. The extraction condition information includes at least the brand information.

The extraction condition information is information relating to times at which the user of the aerosol-generating device 100 uses the aerosol-generating device 100, for example. As described above, the time-related information constitutes, for example, time slot information representing the time slot at the time of inhalation by the user (using the aerosol-generating device 100), or the situation (circumstances) at the time of inhalation, such as “working hours”, “rest period”, “mealtime” (“breakfast”, “lunch”, “dinner”, “drinking party”, or the like), etc. It should be noted that the time slot at the time of inhalation by the user (using the aerosol-generating device 100) may be established by the aerosol-generating device 100, or else a time slot at which input was received from the external device 200 or a time slot designated from the external device 200 may be considered as the time slot at the time of inhalation by the user (using the aerosol-generating device 100). Furthermore, the server device 300 may receive time data from the aerosol-generating device 100 or the external device 200, and the time slot may be established by the server device 300. Furthermore, when the server device 300 has an internal clock, the time at which brand information was received from the external device 200 may be considered as the time of inhalation using the aerosol-generating device 100, and the time slot may be established from that time. To establish the time slot, the server device 300 may establish predefined time slots, such as “morning”=06:00-10:00, “afternoon”=10:00-17:00, “evening”=17:00-24:00, and “night-time”=00:00-06:00, and the server device 300 may establish the time slot from time data output by the aerosol-generating device 100 or the external device 200, or else from the time at which brand information was received by the server device 300. The same also applies to the situation (circumstances) at the time of inhalation, such as “working hours”, and the server device 300 may, for example, establish predefined situations, such as “working hours”=09:00-18:00, “rest period”=15:00-16:00, “breakfast”=07:00-08:00, “lunch”=12:00-13:00, and “dinner”=19:00-20:00, and the server device 300 may establish the situation at the time of inhalation from time data output by the aerosol-generating device 100 or the external device 200, or else from the time at which brand information was received by the server device 300. Alternatively, at the start of inhalation, the user may input the situation at that time by using the dedicated application or website, etc. on the external device 200.

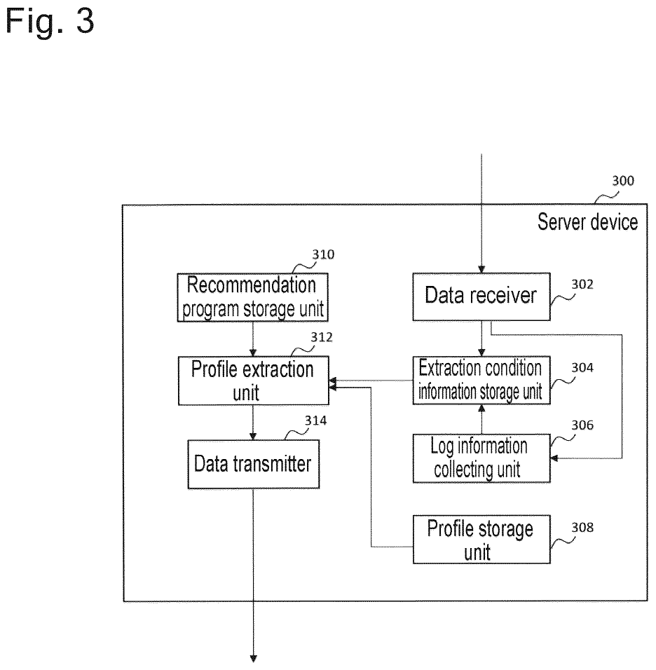

Furthermore, the extraction condition information is inhalation tendency information relating to inhalation tendencies with the aerosol-generating device 100 of the user of the aerosol-generating device 100, for example. The inhalation tendency information constitutes information including, for example: the number of times of inhalation (per single use of the aerosol-generating device 100), the duration of inhalation (per single inhalation), the length of inhalation intervals, the brand information of the aerosol source mainly being inhaled, and the profile mainly being used, etc. FIG. 4 shows an example of the inhalation tendency information. In this example, “device” means the aerosol-generating device 100 used by each user. It should be noted that each user may be caused to pre-register the aerosol-generating device 100 which they are using, on the dedicated application or website, etc. The inhalation tendency information in the example of FIG. 4 constitutes the number of times of inhalation, the duration of inhalation, the length of inhalation intervals, the brand information of the aerosol source mainly being inhaled (brand mainly inhaled), and the profile mainly being used (profile mainly used), etc., for each user (for each aerosol-generating device 100). In FIG. 4, by way of example, there are three values for the number of times of inhalation: “many”, “standard”, and “few”; there are three values for the duration of inhalation: “long”, “standard”, and “short”, and there are three values for the length of inhalation intervals: “long”, “standard”, and “short”. For example, “user X” uses a “device A”, the number of times of inhalation per single use of the aerosol-generating device 100 is “many”, the duration of inhalation is “long”, the length of inhalation intervals is “short”, the brand mainly inhaled is “menthol of brand 1”, and the profile mainly used is “profile B”. In order to simplify the description of this embodiment, the user and the aerosol-generating device 100 are assumed to have a one-to-one relationship, but a single user may also be associated with a plurality of aerosol-generating devices 100. In that case, data may be stored for each of the plurality of devices associated with the single user, as the information illustrated in FIG. 4.

More specifically, the inhalation tendency information such as in FIG. 4 may be established by the following method. That is to say, log information including the number of times of inhalation, etc. is collected in the memory unit 114 of the aerosol-generating device 100 each time the user inhales, and this log information is sent from the aerosol-generating device 100 to the external device 200 when the aerosol-generating device 100 and the external device 200 are connected by means of Bluetooth communication. Furthermore, the log information is sent from the external device 200 to the server device 300. The server device 300 stores the received log information in the log information collecting unit 306. Furthermore, at a predefined timing, the server device 300 calculates average values per number of times of use of the aerosol-generating device 100 for the number of times of inhalation, the inhalation durations, and the inhalation intervals from the log information, and determines that the number of times of inhalation is “many”, “few”, or “standard”, determines that the duration of inhalation is “long”, “short” or “standard”, and determines that the length of inhalation intervals is “long”, “short”, or “standard”, according to whether each average value is greater than a predefined first threshold, equal to or less than a second threshold which is a smaller value than the first threshold, or between the first threshold and the second threshold. It should be noted that the method of determining the number of times of inhalation, etc. is merely an example, and a more exact determination can be made by providing more thresholds. Furthermore, for example, the server device 300 counts the brand information for aerosol sources inhaled and the profiles used, from the log information, and deems the brand information and the profile with the highest count value to be the brand information of the aerosol source mainly being inhaled (brand mainly inhaled) and the profile mainly being used (profile mainly used). It should be noted that this processing in the server device 300 may be implemented in the external device 200, and the inhalation tendency information, which includes the number of times of inhalation, the duration of inhalation, the length of inhalation intervals, the brand information of the aerosol source mainly being used, and the profile mainly being used, may be sent from the external device 200 to the server device 300.

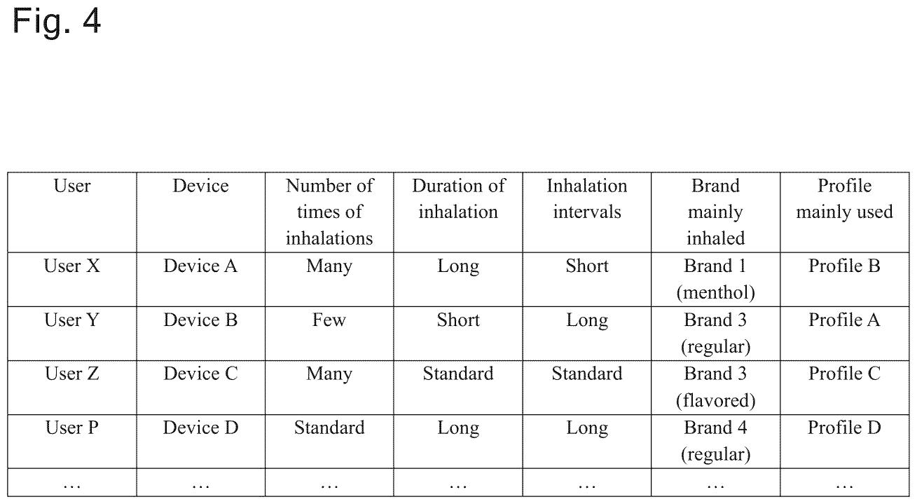

Furthermore, the extraction condition information is attribute information relating to personal data of the user of the aerosol-generating device 100, for example. The attribute information constitutes information such as the user's sex, age, place of residence (or the main place of use of the aerosol-generating device 100, or a region, or the name of a place, etc.), and preferred brands and flavors, etc. FIG. 5 shows an example of the attribute information. In this example, sex, age, region (place of residence), average temperature (of the region), scheme participation history, physical condition, and stimulation are shown for each aerosol-generating device 100 used by the users. Among these, the user may be caused to input their sex, age, region, average temperature (of the region) and scheme participation history in advance (e.g., at the time of first use of the aerosol-generating device 100) by using the dedicated application or website etc. on the external device 200. Furthermore, when the user inputs a region, the server device 300 may acquire the average temperature of that region by referring to data published by a public institution or the like. Furthermore, the scheme participation history is a history of participation of the user in past schemes implemented in regard to the aerosol-generating device 100 by the administrator of the server device 300. User history information such as this is generally held by the administrator of the server device 300, so this history information may be input to the server device 300 by the administrator. Furthermore, “physical condition” and “stimulation” in FIG. 5 indicate the physical condition and the desired feeling from inhalation when the user starts inhaling (the same hereinafter). By way of example, physical condition is expressed by the three values of “good”, “fair” and “poor”, and stimulation is expressed by the three values of “strong”, “medium”, and “weak”. However, this is not limiting. This information may be represented by more stages of values. The user may be caused to input this kind of data each time, by using the dedicated application or website on the external device 200, etc.

Furthermore, the extraction condition information is information relating to the location where the user of the aerosol-generating device 100 uses the aerosol-generating device 100, for example. The place of residence of the user, as in “region (place of residence)” illustrated in FIG. 5 may be considered as the location of use of the aerosol-generating device 100. Alternatively, the user may be caused to input the place of residence using the dedicated application or website, etc. on the external device 200, or else GPS information that can be acquired by the external device may be automatically output to the server device 300.

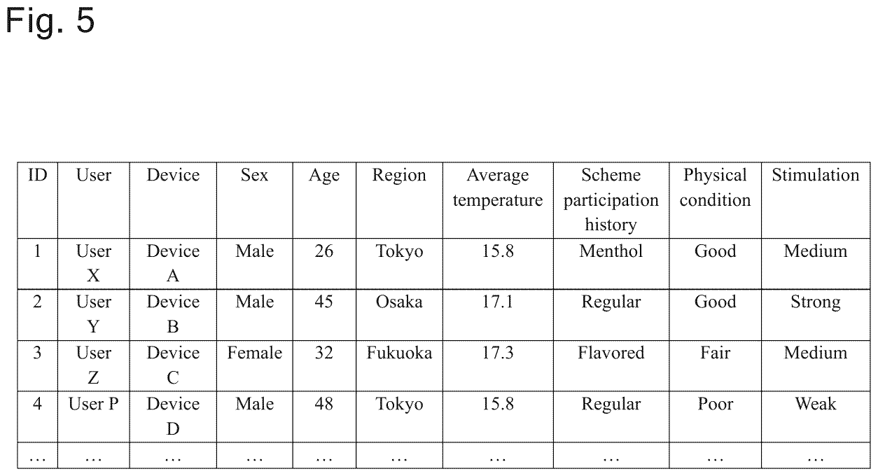

Furthermore, the extraction condition information is preference information relating to preferences of the user of the aerosol-generating device 100, for example. FIG. 6 shows an example of preference information relating to user preferences. In this example, clothing, (favourite) food, standby (screen), and personality assessment are shown for each user (each aerosol-generating device 100). The user may be caused to input such data in advance (e.g., at the time of first use of the aerosol-generating device 100) by using the dedicated application or website etc. on the external device 200. Furthermore, this data may be modified at any time by the user.

Furthermore, the extraction condition information is information dependent on the user at the time when the user of the aerosol-generating device 100 uses the aerosol-generating device 100. Information such as the abovementioned time slot information, region, physical condition and stimulation, for example, may especially correspond to the extraction condition information.

The log information collecting unit 306 stores the log information received by the data receiver 302.

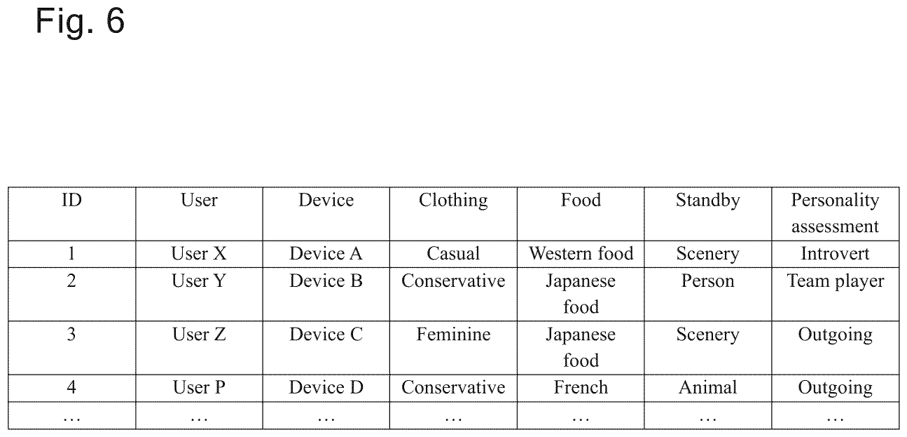

The profile storage unit 308 stores at least one profile in association with the brand information which includes the brand of the aerosol source and information indicating the flavor of the brand. FIG. 7 shows an example of information stored in the profile storage unit 308. In this example, recommended profiles which are recommended for use are associated with respective combinations of brand and flavor constituting the brand information. The administrator of the server device 300 may set the recommended profiles. Furthermore, information such as in FIG. 7 may be present for each user of an aerosol-generating device 100. For example, the profile selected the greatest number of times for each item of brand information from the log information of the user of the aerosol-generating device 100 may be set as the recommended profile. In addition, the profile used most often by other users registered in the server device 300 may also be used as the recommended profile, or similar. It should be noted that one recommended profile is set for one item of brand information in this example, but multiple recommended profiles may be set for one item of brand information.

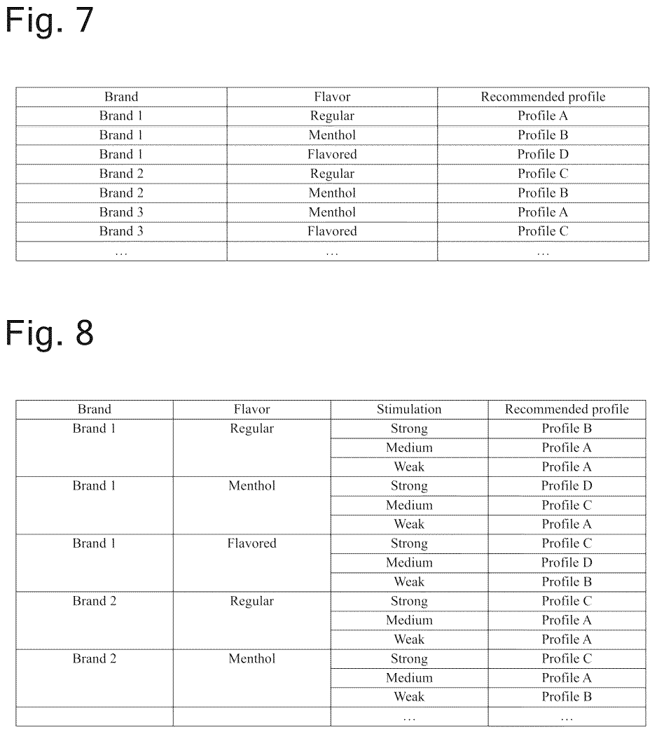

Furthermore, the profile may be stored in the profile storage unit 308 in association with other information. FIG. 8 shows a different example of information stored in the profile storage unit 308. In this example, recommended profiles which are recommended for use are associated with each of the three values (“strong”, “medium”, and “weak”) for stimulation, for respective combinations of “brand” and “flavor” constituting the brand information. The method of setting the recommended profile is the same as in FIG. 7.

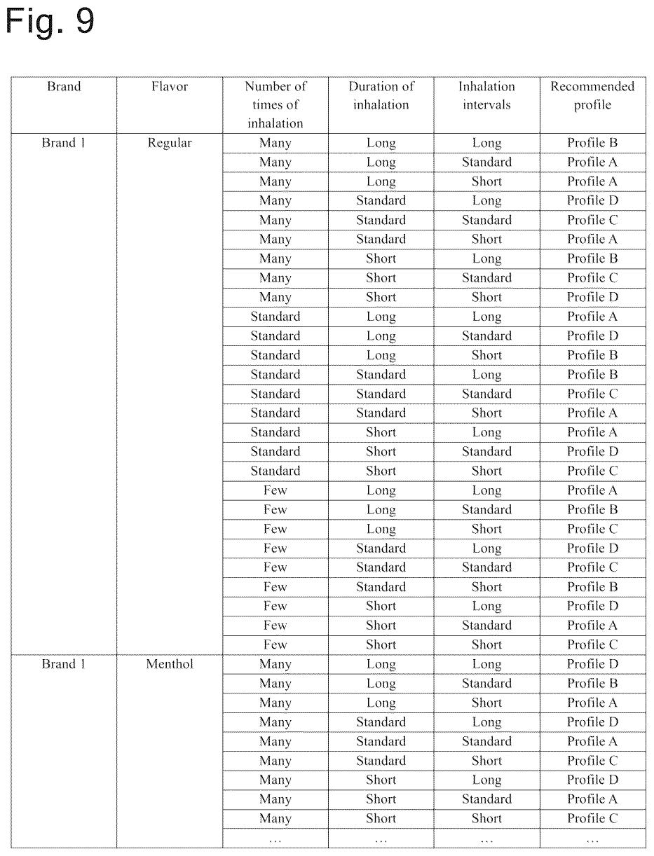

Furthermore, FIG. 9 shows a different example of information stored in the profile storage unit 308. In this example, recommended profiles which are recommended for use are associated with all combinations of number of times of inhalation, duration of inhalation, and length of inhalation intervals, for respective combinations of “brand” and “flavor” constituting the brand information. The method of setting the recommended profile is the same as in FIG. 7.

The recommendation program storage unit 310 stores one or more recommendation programs executed in order to extract a profile in the profile extraction unit 312 which will be described later. The recommendation program storage unit 310 of this embodiment stores four recommendation programs A-D. Recommendation program A is a program for extracting a profile recommended in accordance with brand information acquired from the aerosol-generating device 100. At this time, the recommended profile may be extracted in accordance with the brand included in the brand information, or the recommended profile may be extracted in accordance with the flavor included in the brand information. Recommendation program B is a program for extracting a profile recommended in accordance with brand information acquired from the aerosol-generating device 100, and time slot information. Recommendation program C is a program for extracting a profile recommended in accordance with brand information acquired from the aerosol-generating device 100, and inhalation tendency information. Recommendation program D is a program for extracting a profile recommended in accordance with brand information acquired from the aerosol-generating device 100, inhalation tendency information, and attribute information. The programs A-D are executed in order to extract a recommended profile in the profile extraction unit 312 which will be described later. It should be noted that programs A-D are merely examples.

The profile extraction unit 312 outputs at least one profile applicable to the aerosol-generating device 100, in accordance with information extracted from the aerosol-generating device 100, which includes at least brand information. Furthermore, the profile extraction unit 312 extracts at least one profile applicable to the aerosol-generating device 100 from brand information and extraction condition information.

In this embodiment, the profile extraction unit 312 uses each of the recommendation programs A-D to extract a profile applicable to the aerosol-generating device 100 from at least one profile stored in the profile storage unit 308. The profile extraction unit 312 also deletes duplicate profiles from a set of profiles extracted by the recommendation programs, and assigns an order of priority thereto. A final list of the set of profiles obtained by implementing the processing above is sent to the external device 200 from a data transmitter 314 which will be described later. An example of the method of extracting profiles using each of the recommendation programs A-D will be described below. A description will be given below taking the example of a case in which the data transmitter 302 receives, from the aerosol-generating device 100, brand information for which the brand is “brand 1” and the flavor is “regular”.

### Extraction of Profile Employing Recommendation Program A

Recommendation program A is a program for extracting a profile recommended in accordance with the brand information. The profile extraction unit 312 of this embodiment references the information in FIG. 7 and extracts “profile A” which is associated with brand information for which the brand is “brand 1” and the flavor is “regular”. It should be noted that, at this time, the profile extraction unit 312 may also extract profile A and profile B for which the brand is “brand 1”. However, this is merely an example. The profile selected the greatest number of times when the brand is “brand 1” and the flavor is “regular” may be extracted from log information of the user of the aerosol-generating device 100. A profile better matching the user's preference will be extracted as more user log information is collected. The profile selected the greatest number of times when the brand is “brand 1” and the flavor is “regular” may also be extracted from combined results of log information of other users. This enables a generally popular profile to be proposed to the user.

### Extraction of Profile Employing Recommendation Program B

Recommendation program B is a program for extracting a profile recommended in accordance with brand information and time slot information. In the description here, the time slot information will be “morning”. The server device 300 is preset so as to recommend a profile offering strong stimulation or a profile offering weak stimulation, depending on the time slot. Here, when the time slot is “morning”, the server device 300 is set to extract a profile offering “strong” stimulation, for example. In this case, the profile extraction unit 312 references the information in FIG. 8 and extracts profile B for which the brand is “brand 1”, the flavor is “regular”, and the stimulation is “strong”, for example. However, this is merely an example. For example, instead of brand information and stimulation being associated in the information of FIG. 8, a recommended profile may be associated with each combination of brand information and time slot. Furthermore, the profile selected the greatest number of times for the morning time slot may be extracted from the log information of the user of the aerosol-generating device 100. A profile better matching the user's preference will be extracted as more user log information is collected. Furthermore, the profile selected the greatest number of times for the morning time slot may also be extracted from combined results of log information of other users. This enables a profile which is generally popular for the morning time slot to be proposed to the user. It should be noted that profiles may be extracted by combining some or all of these extraction methods. By extracting a profile using recommendation program B, the user can be provided with a profile commensurate with the time or situation of use of the aerosol-generating device 100, in addition to the brand information.

### Extraction of Profile Employing Recommendation Program C

Recommendation program C is a program for extracting a profile recommended in accordance with brand information and inhalation tendency information. For example, the profile extraction unit 312 references the information in FIG. 4 in order to acquire the number of times of inhalation, duration of inhalation, and inhalation intervals associated with the aerosol-generating device 100 (user) from which brand information was output. In the case of device A (a user X), for example, the information acquired is “many” times of inhalation, a “long” duration of inhalation, and “short” inhalation intervals. The profile extraction unit 312 then references the information in FIG. 9 and outputs “profile A” as the recommended profile associated with a combination in which the brand is “brand 1”, the flavor is “regular”, the number of times of inhalation is “many”, the duration of inhalation is “long”, and the inhalation intervals are “short”. It should be noted that various types of data in the inhalation tendency information used for extracting a profile by means of recommendation program C may constitute part of the above.

### Extraction of Profile Employing Recommendation Program D

Recommendation program D is a program for extracting a profile recommended in accordance with brand information, inhalation tendency information and attribute information. For example, the profile extraction unit 312 references the information in FIG. 4 in order to acquire the number of times of inhalation, duration of inhalation, and inhalation intervals (inhalation tendency information) associated with the aerosol-generating device 100 (user) from which brand information was sent. The profile extraction unit 312 also references the information in FIG. 5 in order to acquire information (attribute information) relating to sex, age, region (place of residence), average temperature (of the region), scheme participation history, physical condition, and stimulation, associated with the aerosol-generating device 100 (user) from which brand information was output. Here, the profile extraction unit 312 of this embodiment extracts, as recommended profiles, profiles selected by other users for which a degree of similarity with the acquired brand information, inhalation tendency information and attribute information is higher than a predefined threshold. Furthermore, if a large number of profiles are extracted, recommended profiles may again be extracted while raising the threshold for degree of similarity. Furthermore, profiles which are more popular may be extracted by also taking account of other indicators such as a profile popularity ranking. Furthermore, the profile extraction unit 312 may also reference the preference information in FIG. 6, in addition to the brand information, inhalation tendency information and attribute information, and may extract profiles selected by other users with a high degree of similarity, with preference information also included, and may further extract profiles by also taking account of other indicators such as a popularity ranking. It should be noted that various types of data in the inhalation tendency information and attribute information used for extracting a profile by means of recommendation program D may constitute part of the above.

The profile extraction unit 312 of this embodiment extracts one or more recommended profiles by means of recommendation programs A-D, as described above. Duplicate profiles are then deleted from the extracted profiles, an order of priority is assigned, and a final list of recommended profiles is generated.

Returning to FIG. 3, the data transmitter 314 sends various types of data to the external device 200 by means of wired or wireless communication. The data transmitter 314 of this embodiment outputs to the external device 200 the list of one or more recommended profiles extracted by the profile extraction unit 312. The external device 200 outputs the list of one or more profiles sent from the data transmitter 314 so that the user can be made aware of this list of profiles by displaying the list on a display device of the external device 200, etc., and a user input operation designating which of the profiles is to be used in the aerosol-generating device 100 is received via an input interface such as a touch panel. Furthermore, the external device 200 stores a list of profiles already downloaded by the aerosol-generating device 100 to the memory unit 114, and checks whether the profile designated by the user is included in the list of downloaded profiles, then, if the profile is not included in the list, sends information requesting data of the profile to the server 300. The server device 300 sends data of the profile requested by the external device to the external device 200 via the data transmitter 314. The external device 200 outputs to the aerosol-generating device 100 the data of the profile sent from the server device 300. The aerosol-generating device 100 stores the data of the profile sent from the external device 200 in the memory unit 114, while the control unit 116 also implements control of the heating process performed by the heating unit 121 using this profile.

However, the method of downloading the profile to the aerosol-generating device 100 is not limited to such a method. For example, the server device 300 may also output the list of one or more profiles extracted by the profile extraction unit 312 directly to the aerosol-generating device 100, without passing via the external device 200. User input for selecting the profile to be used by the aerosol-generating device 100 may then be received via an input device such as a button or a switch, and if the data of the selected profile is not stored in the memory unit 114, this data may be downloaded from the server device 300 and heating control may be implemented.

### Hardware Configuration of Server Device

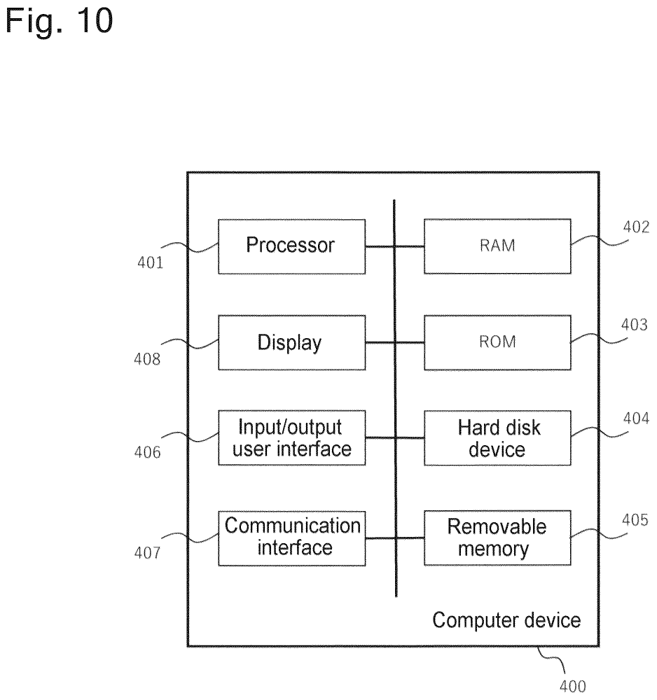

The server device 300 according to this embodiment may be realized by the same hardware configuration as for a typical computer device. FIG. 10 shows a hardware configuration example of the server 300. A computer device 400 shown in FIG. 10 comprises, by way of example: a processor 401; a RAM (random access memory) 402; a ROM (read-only memory) 403; a built-in hard disk device 404; a removable memory 405 such as an external hard disk device, CD, DVD, USB memory, memory stick or SD card; an input/output user interface (keyboard, mouse, touch panel, speaker, microphone, LED (light-emitting diode), etc.) for input/output of data by the user to/from the computer device 400, a wired/wireless communication interface 407 capable of communicating with another computer device; and a display 408. The processor 401 may be realized by a CPU or an electronic circuit such as a microprocessor, for example.

The abovementioned extraction condition information storage unit 304, log information collecting unit 306, profile storage unit 308, and recommendation program storage unit 310 may be configured by any or a combination of the RAM 402, the ROM 403, the hard disk device 404, and the removable memory 405. Furthermore, the abovementioned data receiver 302 and data transmitter 314 may be configured by the communication interface 407. Furthermore, the functions of the server device 300 according to the embodiment described above may be realized, for example, by the processor 401 appropriately reading programs and data required for processing, which are stored in memory areas such as the hard disk device 404, ROM 403, and removable memory 405, to a memory area such as the RAM 403, and then implementing said programs and data. For example, the profile extraction unit 312 may implement the recommended profile extraction processing as a result of the processor 401 reading the program data of recommendation programs A-D and data for processing, which are stored in memory areas such as the hard disk device 404, ROM 403, and removable memory 405, in succession to the RAM 403, and then processing this data.

It should be noted that, in FIG. 10, the server device 300 is depicted as a single computer device 400, but the server device may equally be configured by two or more computer devices. Moreover, the hardware configuration shown in FIG. 10 is merely an example, and is not limited to such an example.

Furthermore, some or all of the various types of programs for implementing the functions of the server device 300 according to this embodiment, including the recommendation programs A-D, etc., may be stored in a computer readable medium, or may be downloaded via a wired or wireless communication network, etc.

### Processing Flow of Heating Profile Provision System

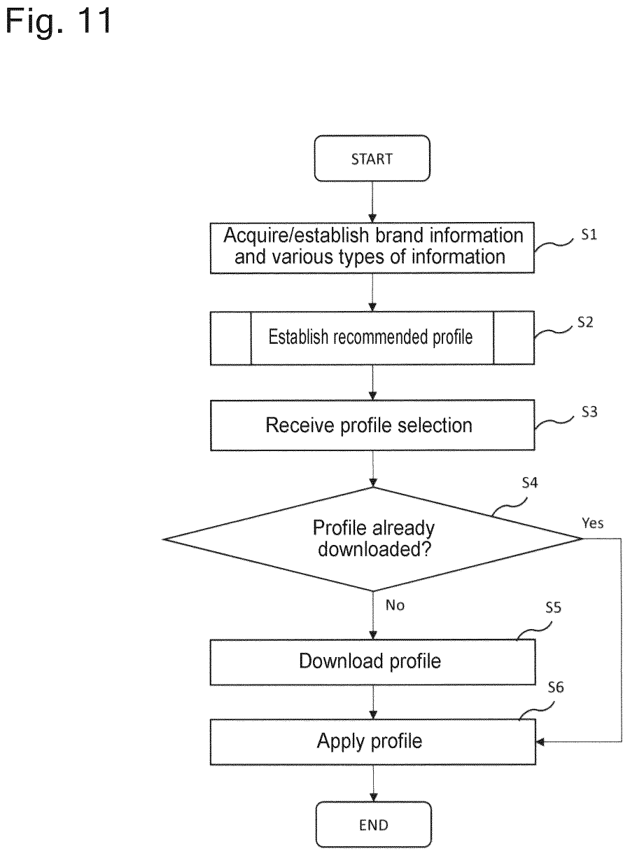

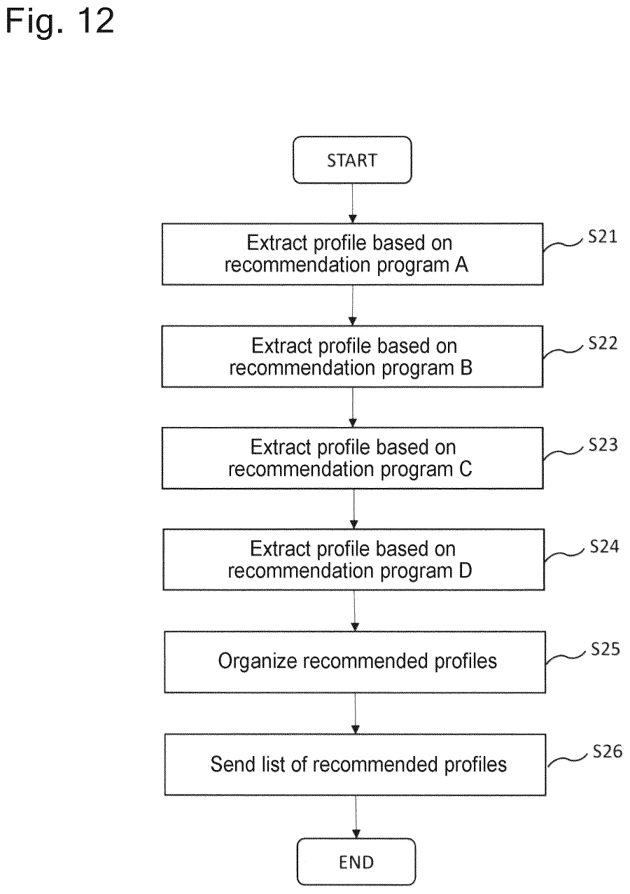

FIGS. 11 and 12 show an example of the processing flow of the heating profile provision system 1. FIG. 11 shows an example of the main processing flow. FIG. 12 shows an example of a detailed processing flow in step S2.

Referring to FIG. 11, in step S1, the server device 300 acquires, via the external device 200, brand information output from the aerosol-generating device 100. Furthermore, the server device 300 acquires or establishes various types of information such as the time slot information, inhalation tendency information, attribute information and preference information relating to the user of the aerosol-generating device 100. Furthermore, the server device 300 appropriately acquires and collects, in advance, log information of registered users including other users.

In step S2, the server device 300 establishes recommended profiles for the aerosol-generating device 100 in accordance with the various types of information such as time slot information, inhalation tendency information, attribute information and preference information which were acquired in step S1, and in accordance with the recommendation programs A-D, and outputs a list of the recommended profiles to the external device 200 (the details of the processing of step S2 are illustrated in FIG. 12).

In step S3, the external device 200 receives a user operation for selecting the profile to be applied to the aerosol-generating device 100 from the list of recommended profiles. In step S4, the external device 200 determines whether the profile selected by the user operation in S3 has already been downloaded to the aerosol-generating device 100. In step S5, the external device 200 requests from the server 300 data of a profile which has not been downloaded to the aerosol-generating device 100, and downloads the data of that profile from the server device 300. The data of the downloaded profile is sent to the aerosol-generating device 100.

In step S6, the aerosol-generating device 100 receives the data of the profile from the external device 200 and applies this profile to the process of heating the aerosol source 120, etc.

FIG. 12 is a flowchart showing an example of the details of the processing in step S2. In step S21, the server device 300 extracts a recommended profile based on recommendation program A. In step S22, the server device 300 extracts a recommended profile based on recommendation program B. In step S23, the server device 300 extracts a recommended profile based on recommendation program C. In step S24, the server device 300 extracts a recommended profile based on recommendation program D.

In step S25, the server device 300 organizes the recommended profiles extracted in steps S21-S24. Specifically, the server device 300 deletes duplicate recommended profiles from among the one or more recommended profiles extracted in steps S21-S24, and assigns an order of priority to generate a final list of recommended profiles. In step S26, the server device 300 sends to the external device 200 the list of recommended profiles generated in step S25.

### Variant Examples

In the embodiments above, the sensor unit 112 of the aerosol-generating device 100 included a sensor for reading two-dimensional codes, and the brand was read from the QR code attached to the refills 120, 130 or the stick-type substrate 150, but the brand may equally be read by the external device 200. For example, the aerosol-generating device 100 only images the QR code attached to the refills 120, 130 or the stick-type substrate 150, and sends an image of the imaged QR code to the external device 200. When the external device 200 receives the image of the QR code, the external device 200 may image this image using an imaging device provided in the external device 200 to thereby read the brand information of the refills 120, 130 or the stick-type substrate 150 from this QR code, then the external device 200 may send the brand information to the server device 300.

The heating profile provision method, system and program according to the embodiment described above enable a suitable profile to be recommended to a user according to the flavor of an aerosol source heated by the aerosol-generating device 100. A more suitable profile may be recommended to the user depending on the preference of the user and the situation of the user at the time of inhalation.

Embodiments of the present disclosure were described above together with variant examples and modes of application thereof, but these are merely examples and should not be understood as limiting the scope of the present disclosure. It should be understood that modifications, additions, and improvements, etc. may be appropriately made to the embodiments, without departing from the essence and scope of the present disclosure. The scope of the present disclosure should not be limited by any of the embodiments described above, and should be defined solely by the scope of the claims and equivalents thereto.

It should be noted that the following configurations also fall within the technical scope of the present invention.

### (1)

A method executed by means of a computer device, wherein
the computer device comprises:
   a profile storage unit for storing a plurality of profiles for controlling a heating process in an aerosol-generating device for generating an aerosol, the profiles being stored in association with brand information including a brand of an aerosol source undergoing the heating process in the aerosol-generating device and information indicating a flavor of the brand; and
an extraction condition information storage unit for storing extraction condition information which is information dependent on a user of the aerosol-generating device and is information for extracting at least one profile from among the plurality of profiles,
wherein
the profile storage unit further stores the plurality of profiles and the extraction condition information in association with each other, and
the method comprises:
   a step of extracting at least one profile applicable to the aerosol-generating device from among the plurality of profiles, based on the brand information and the extraction condition information stored in the extraction condition storage unit.

### (2)

The method as disclosed in (1) above, wherein the extraction condition information is information relating to a time at which the user uses the aerosol-generating device.

### (3)

The method as disclosed in (1) or (2) above, wherein the extraction condition information is inhalation tendency information relating to an inhalation tendency of the user of the aerosol-generating device.

### (4)

The method as disclosed in any one of (1) to (3) above, wherein the extraction condition information is attribute information relating to personal data of the user.

### (5)

The method as disclosed in any one of (1) to (4) above, wherein the extraction condition information is information relating to a location where the user uses the aerosol-generating device.

### (6)

The method as disclosed in any one of (1) to (5) above, wherein the extraction condition information is preference information relating to a preference of the user.

### (7)

The method as disclosed in any one of (1) to (6) above, wherein the extraction condition information is information dependent on the user at a time when the user uses the aerosol-generating device.

### (8)

The method as disclosed in any one of (1) to (7) above, further comprising a step of receiving the extraction condition information from externally to the computer device.

### (9)

The method as disclosed in any one of (1) to (8) above, further comprising a step of outputting a list of said at least one profile extracted in the step of extracting said at least one profile.

### (10)

A computer device for providing a profile for controlling a heating process in an aerosol generating device for generating an aerosol, the computer device comprising:
a profile storage unit for storing a plurality of said profiles in association with brand information including a brand of an aerosol source undergoing the heating process in the aerosol-generating device and information indicating a flavor of the brand; and an extraction condition information storage unit for storing extraction condition information which is information dependent on a user of the aerosol-generating device and is information for extracting at least one profile from among the plurality of profiles,
wherein
the profile storage unit further stores the plurality of profiles and the extraction condition information in association with each other, and
the computer device further comprises a profile extraction unit for extracting at least one profile applicable to the aerosol-generating device from among the plurality of profiles, based on the brand information and the extraction condition information stored in the extraction condition storage unit.

### (11)

A program for causing a computer device to execute the method as disclosed in any one of (1) to (9) above.

### REFERENCE SIGNS LIST

100 . . . Aerosol-generating device, 110 . . . Power supply unit, 111 . . . Power source unit, 112 . . . Sensor unit, 113 . . . Notification unit, 114 . . . Memory unit, 115 . . . Communication unit, 116 . . . Control unit, 117 . . . Detection unit, 120 . . . Refill, cartridge, aerosol source, 121 . . . Heating unit, 122 . . . Liquid guiding portion, 123 . . . Liquid storage portion, 124 . . . Mouthpiece, 130 . . . Flavoring cartridge, 131 . . . Flavor source, 140 . . . Holding portion, 141 . . . Internal space, 142 . . . Opening, 143 . . . Bottom portion, 144 . . . Heat insulating portion, 150 . . . Stick-type substrate, 151 . . . Substrate portion, 152 . . . Mouthpiece portion, 180 . . . Air flow path, 181 . . . Air inflow hole, 182 . . . Air outflow hole, 190 . . . Arrow, 200 . . . External device, 300 . . . Server device, 302 . . . Data receiver, 304 . . . Extraction condition information storage unit, 306 . . . Log information collecting unit, 308 . . . Profile storage unit, 310 . . . Recommendation program storage unit, 312 . . . Profile extraction unit, 314 . . . Data transmitter, 400 . . . Computer device, 401 . . . Processor, 404 . . . Hard disk device, 405 . . . Removable memory, 406 . . . Input/output user interface, 407 . . . Communication interface, 408 . . . Display

1. A method executed by means of a computer device, wherein
the computer device comprises:
a profile storage unit for storing a plurality of profiles for controlling a heating process in an aerosol-generating device for generating an aerosol, the profiles being stored in association with brand information including a brand of an aerosol source undergoing the heating process in the aerosol-generating device and information indicating a flavor of the brand; and
an extraction condition information storage unit for storing extraction condition information which is information dependent on a user of the aerosol-generating device and is information for extracting at least one profile from among the plurality of profiles, and
wherein
the profile storage unit further stores the plurality of profiles and the extraction condition information in association with each other, and
the method comprises:
a step of extracting at least one profile applicable to the aerosol-generating device from among the plurality of profiles, based on the brand information and the extraction condition information stored in the extraction condition storage unit.

2. The method as claimed in claim 1, wherein the extraction condition information is information relating to a time at which the user uses the aerosol-generating device.

3. The method as claimed in claim 1, wherein the extraction condition information is inhalation tendency information relating to an inhalation tendency of the user of the aerosol-generating device.

4. The method as claimed in claim 1, wherein the extraction condition information is attribute information relating to personal data of the user.

5. The method as claimed in claim 1, wherein the extraction condition information is information relating to a location where the user uses the aerosol-generating device.

6. The method as claimed in claim 1, wherein the extraction condition information is preference information relating to a preference of the user.

7. The method as claimed in claim 1, wherein the extraction condition information is information dependent on the user at a time when the user uses the aerosol-generating device.

8. The method as claimed in claim 1, further comprising a step of receiving the extraction condition information from externally to the computer device.

9. The method as claimed in claim 1 further comprising a step of outputting a list of said at least one profile extracted in the step of extracting said at least one profile.

10. A computer device for providing a profile for controlling a heating process in an aerosol-generating device for generating an aerosol, the computer device comprising:
a profile storage unit for storing a plurality of said profiles in association with brand information including a brand of an aerosol source undergoing the heating process in the aerosol-generating device and information indicating a flavor of the brand; and
an extraction condition information storage unit for storing extraction condition information which is information dependent on a user of the aerosol-generating device and is information for extracting at least one profile from among the plurality of profiles,
wherein
the profile storage unit further stores the plurality of profiles and the extraction condition information in association with each other, and
the computer device further comprises a profile extraction unit for extracting at least one profile applicable to the aerosol-generating device from among the plurality of profiles, based on the brand information and the extraction condition information stored in the extraction condition storage unit.

11. A non-transitory computer-readable medium storing a program for causing a computer device to execute the method as claimed in claim 1.
